(19) United States
(12) Patent Application Publication
(10) Pub. No.: US 2017/0361768 A1
(43) Pub. Date: Dec. 21, 2017

(54) PORTABLE EMERGENCY SIGN DEVICE FOR VEHICLE

(71) Applicant: Youngcheol KIM, Changwon-si (KR)

(72) Inventors: Youngcheol KIM, Changwon-si (KR); Dongkyu JIN, Yangsan-si (KR)

(73) Assignee: Youngcheol KIM, Changwon-si (KR)

(21) Appl. No.: 15/206,168

(22) Filed: Jul. 8, 2016

(30) Foreign Application Priority Data
Jun. 17, 2016 (KR) 10-2016-0075617

(51) Int. Cl. B60Q 1/52

(52) U.S. Cl. CPC B60Q 1/52

(57) ABSTRACT

Disclosed herein is a portable emergency sign device for a vehicle. The portable emergency sign device includes a box-shaped case body, a main laser oscillator, and a reflector. The box-shaped case body provides an installation space therein. The main laser oscillator is installed within the case body, and radiates laser light adapted to display the location region of a vehicle in trouble. The reflector is installed to be selectively projected out of and accommodated within the case body, and reflects the laser light, radiated by the main laser oscillator, onto a road surface.

### BACKGROUND

### 1. Technical Field

The present invention relates generally to an emergency warning device, and more particularly to a new type of portable emergency sign device for a vehicle, which enables a sign to be displayed across a wide range of region in order to prevent the following vehicle from bumping into the rear of a vehicle upon an emergency stop attributable to an accident or breakdown of the vehicle, thereby enabling the following vehicle to accurately become aware of the state of the vehicle in trouble.

### 2. Description of the Related Art

In general, upon an emergency stop attributable to an accident or breakdown of a vehicle during traveling, measures to provide notification of the vehicle in trouble must be taken in order to ensure not only the safety of the vehicle in trouble but also the safety of another vehicle.

Conventionally, when a vehicle cannot travel on a road any longer, a warning triangle or a flare signal device is erected and installed on a ground surface behind the vehicle, thereby preventing a secondary accident.

However, the warning triangle does not have excellent nighttime distinctiveness, and thus there still exists concern about a secondary accident.

Recently, various emergency sign devices have been proposed in order to overcome the above-described problems. A representative one of these devices is a method that displays an emergency warning on a ground surface behind a vehicle using laser light. That is, this method enables the following vehicle to accurately become aware of the presence of a vehicle in trouble by displaying a warning triangle on a road using laser light. Technologies related to this method are disclosed in Korean Patent No. 10-1434791, Korean Patent No. 10-1296248, Korean Patent No. 10-1445274, and Korean Patent Application Publication No. 10-2007-46060.

However, the conventional emergency sign devices display a character or a diagram only in a limited region due to the characteristics of laser light, but cannot display a character or a diagram throughout a wide range of region.

Furthermore, the conventional emergency sign devices are provided in the state of being integrated with a vehicle, and thus the possibility of damage attributable to an external impact is always present.

Furthermore, the conventional emergency sign devices cannot perform display in connection with a traffic lane.

Furthermore, when the conventional emergency sign devices are used, the following vehicle cannot become aware of the type of trouble and, thus, cannot provide help.

### SUMMARY

The present invention has been devised to overcome the problems of the above-described prior art, and an object of the present invention is to provide a new type of portable emergency sign device for a vehicle, which enables a sign to be displayed across a wide range of region in order to prevent the following vehicle from bumping into the rear of a vehicle upon an emergency stop attributable to an accident or breakdown of the vehicle, thereby enabling the following vehicle to accurately become aware of the state of the vehicle in trouble.

In accordance with an aspect of the present invention, there is provided a portable emergency sign device for a vehicle, including: a box-shaped case body configured to provide an installation space therein; a main laser oscillator installed within the case body, and configured to radiate laser light adapted to display the location region of a vehicle in trouble; and a reflector installed to be selectively projected out of and accommodated within the case body, and configured to reflect the laser light, radiated by the main laser oscillator, onto a road surface.

A through hole may be famed through the top surface of the case body; and the reflector may be installed to be exposed out of the case body through the through hole by a lifting and lowering unit.

The lifting and lowering unit may include a drive motor configured to have a pinion, and a rack configured such that the rack is engaged with the pinion and selectively lifted and lowered along with the pinion and such that the reflector is installed on the rack.

An operation switch configured to control the operation of the drive motor may be provided on the outer surface of the case body.

An opening and closing cover configured selectively open and close the through hole of the case body while being selectively lifted and lowered along with the reflector may be provided above the reflector.

The reflector may be gradually forwardly projected along a direction toward a center thereof and is thus rounded, and may enable the laser light, radiated by the main laser oscillator, to display a sign adapted to partially surround a region behind the vehicle in trouble.

The portable emergency sign device may further include an access blocking sign laser oscillator configured to radiate laser light onto a ground surface so that a sign adapted to block approach of a vehicle is displayed.

The access blocking sign laser oscillator may be located on at least any one of both sides of the reflector.

The portable emergency sign device may further include a traffic lane change guidance laser oscillator configured to radiate laser light onto a ground surface so that a sign adapted to guide the following vehicle through avoidance of a traffic lane where the vehicle in trouble is located is displayed.

The traffic lane change guidance laser oscillator may be located on at least any one of both sides of the reflector.

The portable emergency sign device may further include a trouble type display laser oscillator configured to radiate laser light onto a ground surface so that a sign adapted to indicate the type of trouble of the vehicle in trouble is displayed.

The trouble type display laser oscillator may be located on at least any one of both sides of the reflector.

The sign adapted to indicate the type of trouble of the vehicle in trouble may be at least any one of a diagram indicating that a vehicle is in the process of repairing and a diagram indicating lack of fuel or a flat tire.

The portable emergency sign device may further include a warning triangle installed behind the case body to be selectively folded and extended and configured to perform display so that whether a vehicle is in trouble is recognized during daytime.

A triangle holder configured to accommodate and install the warning triangle may be formed to be bent behind the case body.

The portable emergency sign device may further include a seat pad made of rubber and provided on the bottom surface of the case body.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a plan view illustrating the state in which a portable emergency sign device for a vehicle according to an embodiment of the present invention is installed;

FIG. 2 is a front view illustrating the state in which the portable emergency sign device for a vehicle according to the embodiment of the present invention is installed;

FIG. 3 is a perspective view illustrating the state in which the portable emergency sign device for a vehicle according to the embodiment of the present invention is not in use, when viewed from the front;

FIG. 4 is a view illustrating the internal state in which the portable emergency sign device for a vehicle according to the embodiment of the present invention is not in use;

FIG. 5 is a perspective view illustrating the state in which the portable emergency sign device for a vehicle according to the embodiment of the present invention is in use, when viewed from the front;

FIG. 6 is a view illustrating the internal state in which the portable emergency sign device for a vehicle according to the embodiment of the present invention is in use;

FIG. 7 is a view illustrating the internal state in which the portable emergency sign device for a vehicle according to the embodiment of the present invention provides a region display sign;

FIG. 8 is a plan view illustrating the state in which the portable emergency sign device for a vehicle according to the embodiment of the present invention provides a region display sign;

FIG. 9 is a front view illustrating the state in which the portable emergency sign device for a vehicle according to the embodiment of the present invention provides a region display sign;

FIG. 10 is a view illustrating the internal state in which the portable emergency sign device for a vehicle according to the embodiment of the present invention provides an access blocking sign;

FIG. 11 is a plan view illustrating the state in which the portable emergency sign device for a vehicle according to the embodiment of the present invention provides an access blocking sign;

FIG. 12 is a front view illustrating the state in which the portable emergency sign device for a vehicle according to the embodiment of the present invention provides an access blocking sign;

FIG. 13 is a plan view illustrating the state in which the portable emergency sign device for a vehicle according to the embodiment of the present invention provides a traffic lane change guidance sign;

FIG. 14 is a front view illustrating the state in which the portable emergency sign device for a vehicle according to the embodiment of the present invention provides a traffic lane change guidance sign;

FIG. 15 is a view illustrating the internal state of a portable emergency sign device for a vehicle according to another embodiment of the present invention;

FIG. 16 is a perspective view illustrating the portable emergency sign device for a vehicle according to the other embodiment of the present invention;

FIG. 17 is a view illustrating the state in which the warning triangle of the portable emergency sign device for a vehicle according to the other embodiment of the present invention is extended;

FIG. 18 is a plan view illustrating the state in which the portable emergency sign device for a vehicle according to the embodiment of the present invention provides a trouble type display sign;

FIG. 19 is a front view illustrating the internal state of another example of the lifting and lowering unit of the portable emergency sign device for a vehicle according to the embodiment of the present invention;

FIG. 20 is a plan view illustrating the internal state of the other example of the lifting and lowering unit of the portable emergency sign device for a vehicle according to the embodiment of the present invention;

FIG. 21 is a front view illustrating the operating state of the other example of the lifting and lowering unit of the portable emergency sign device for a vehicle according to the embodiment of the present invention; and

FIG. 22 is a plan view illustrating the operating state of the other example of the lifting and lowering unit of the portable emergency sign device for a vehicle according to the embodiment of the present invention.

### DETAILED DESCRIPTION

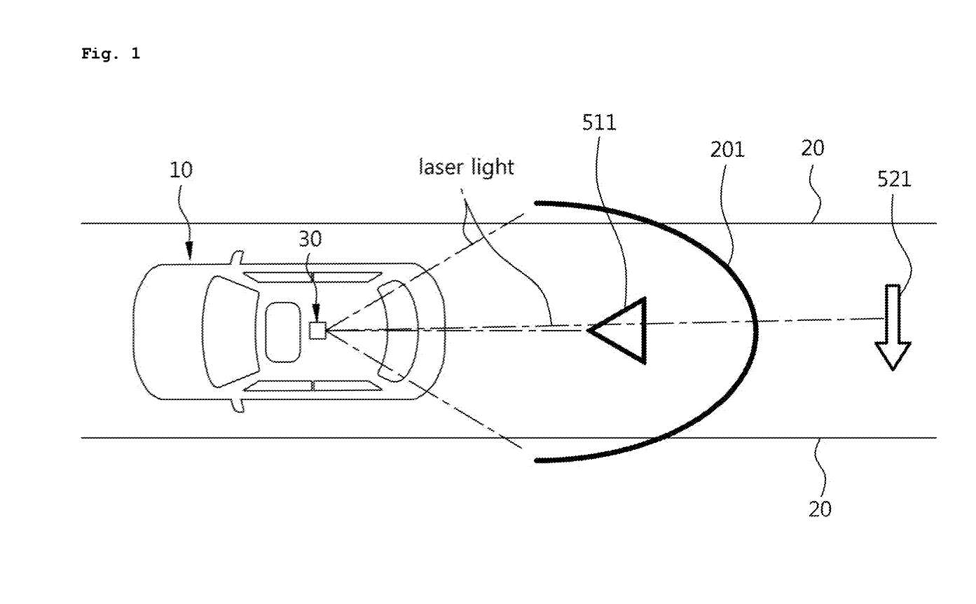

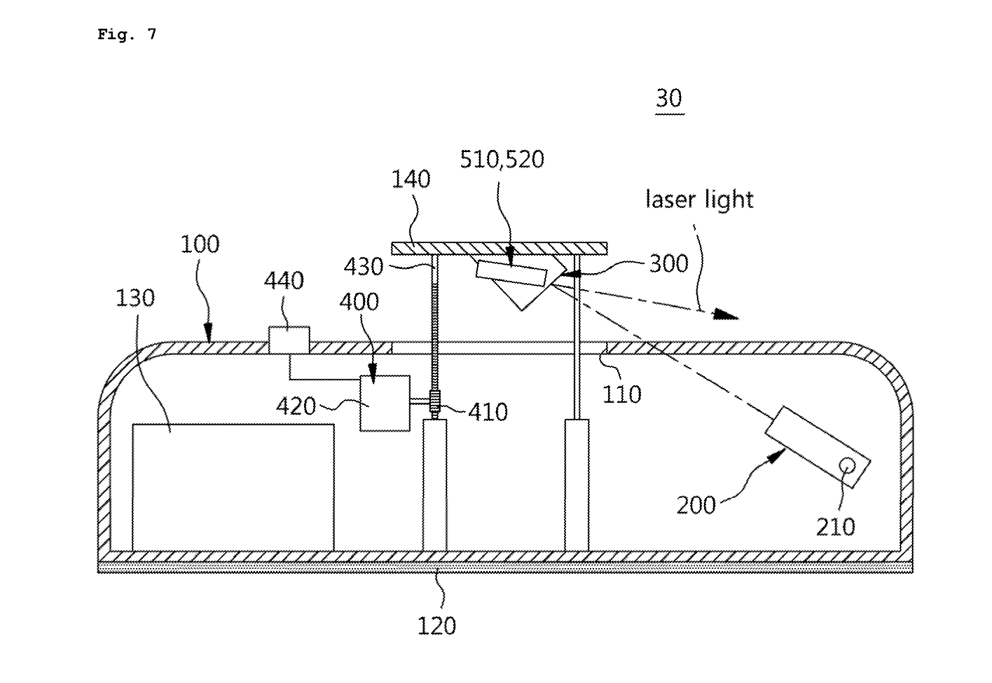

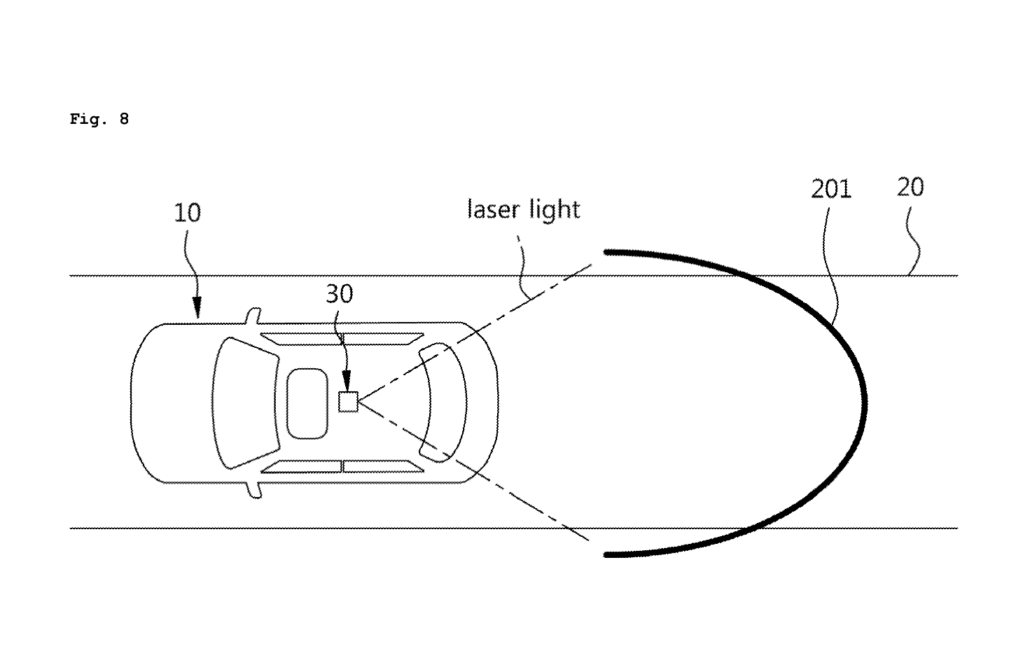

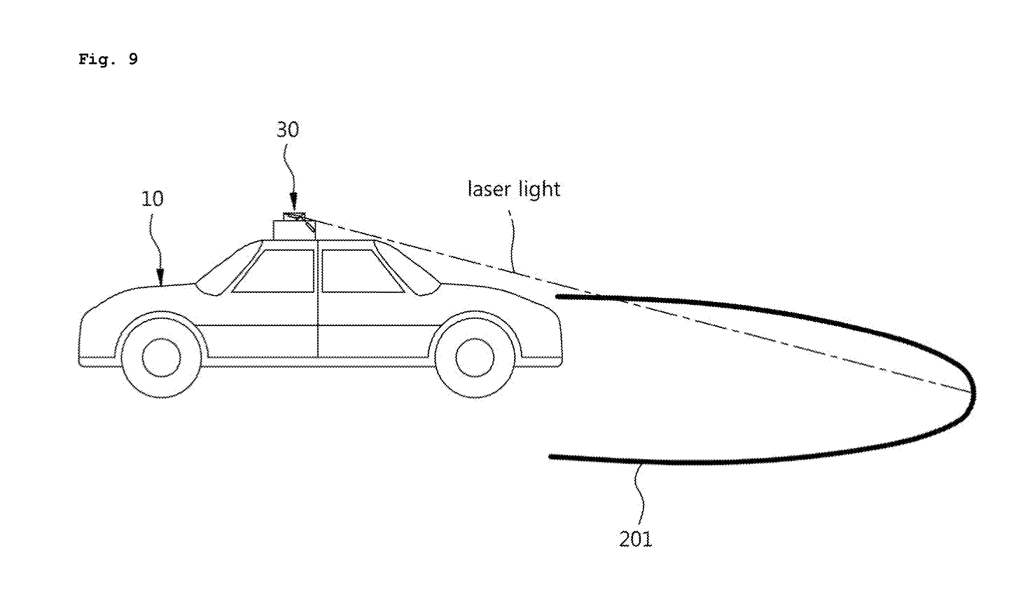

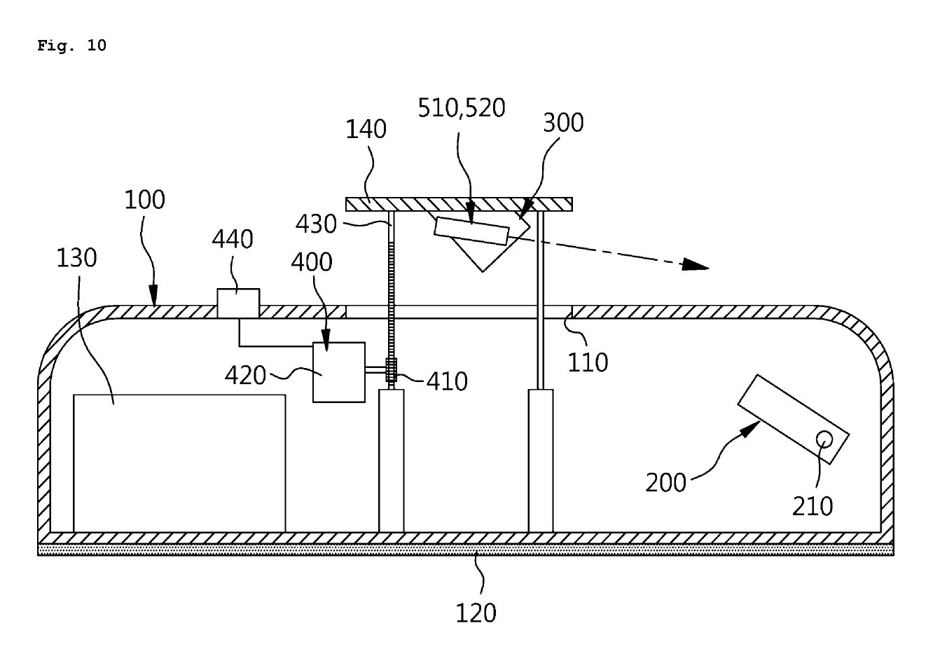

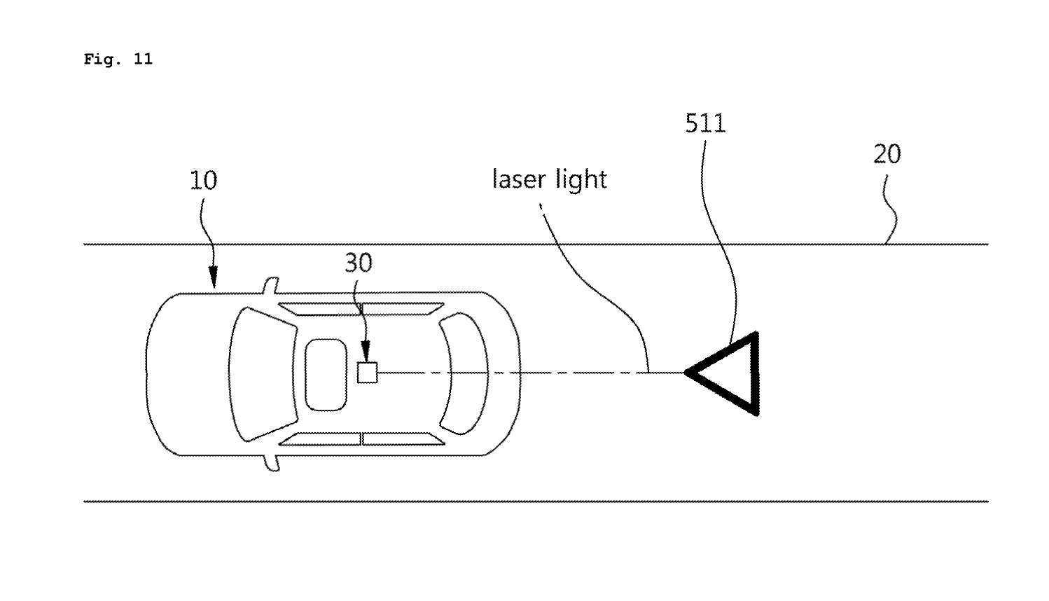

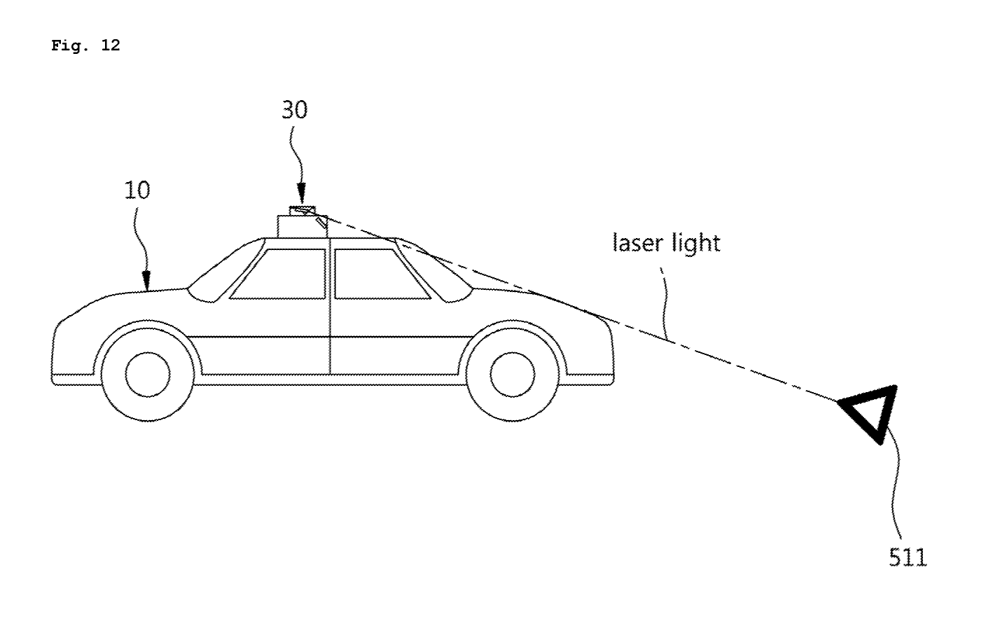

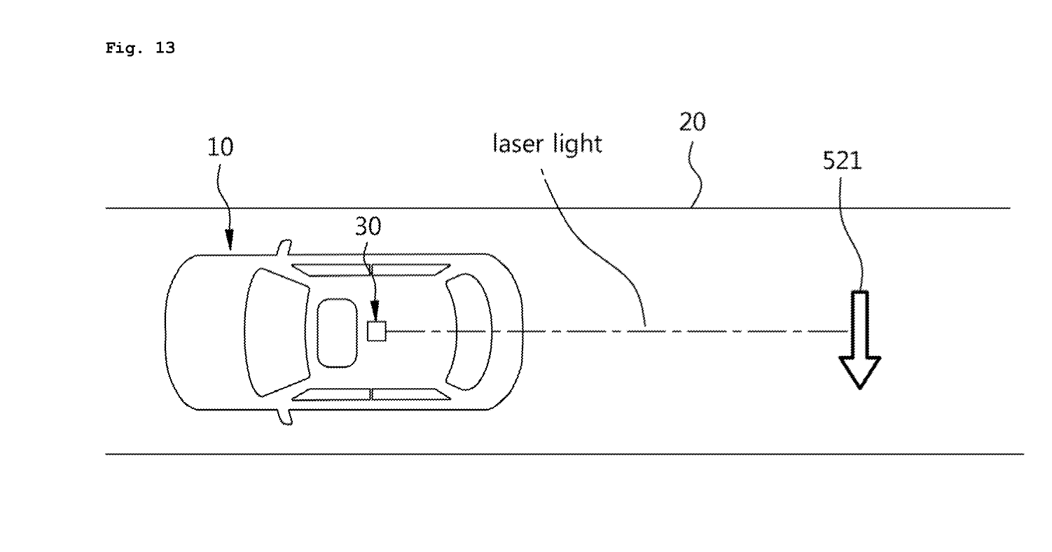

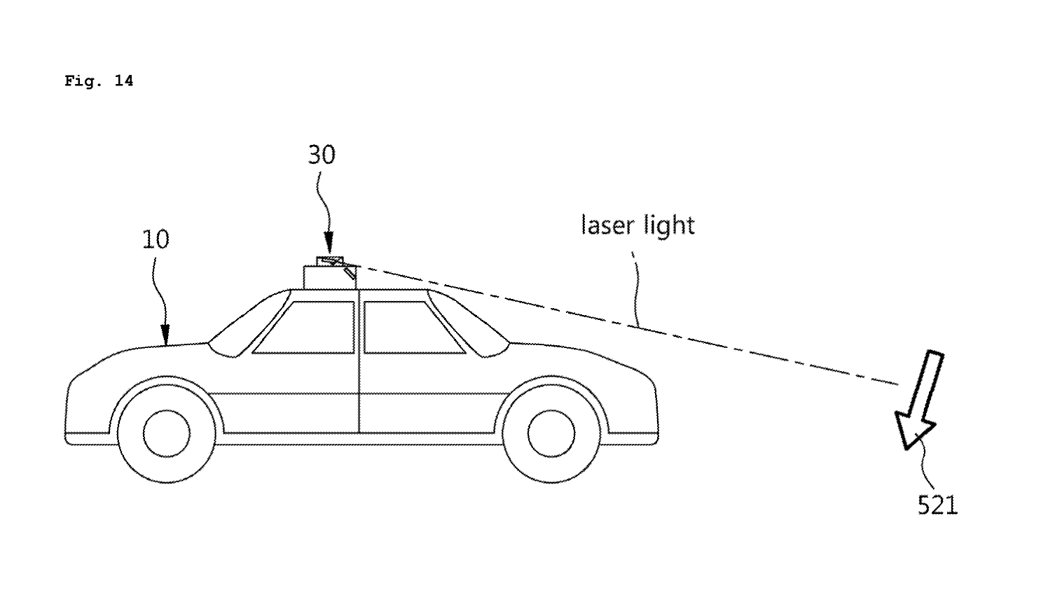

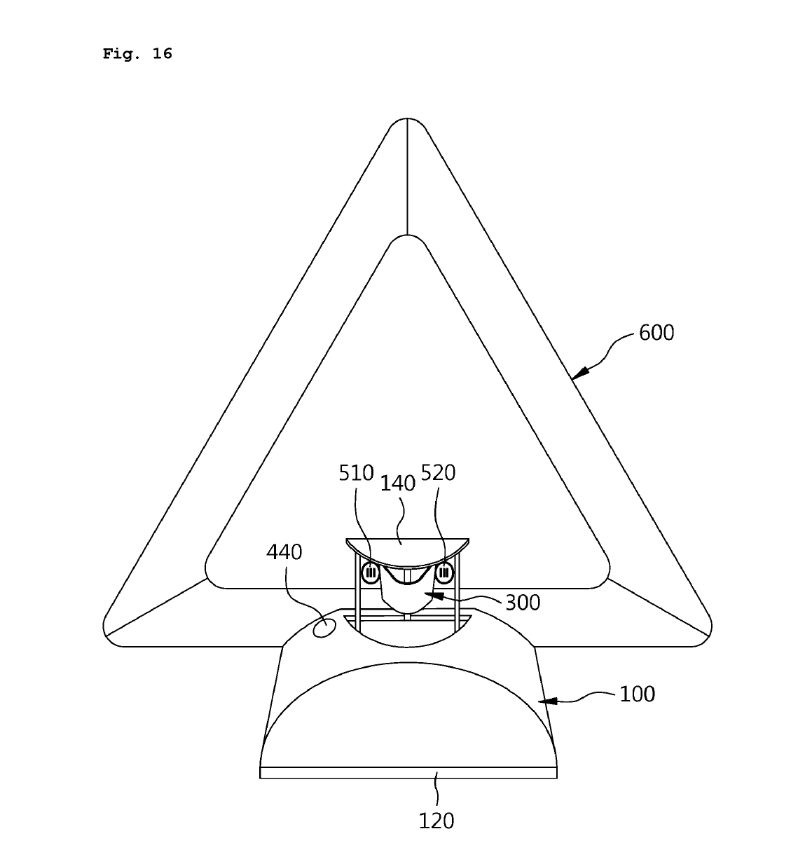

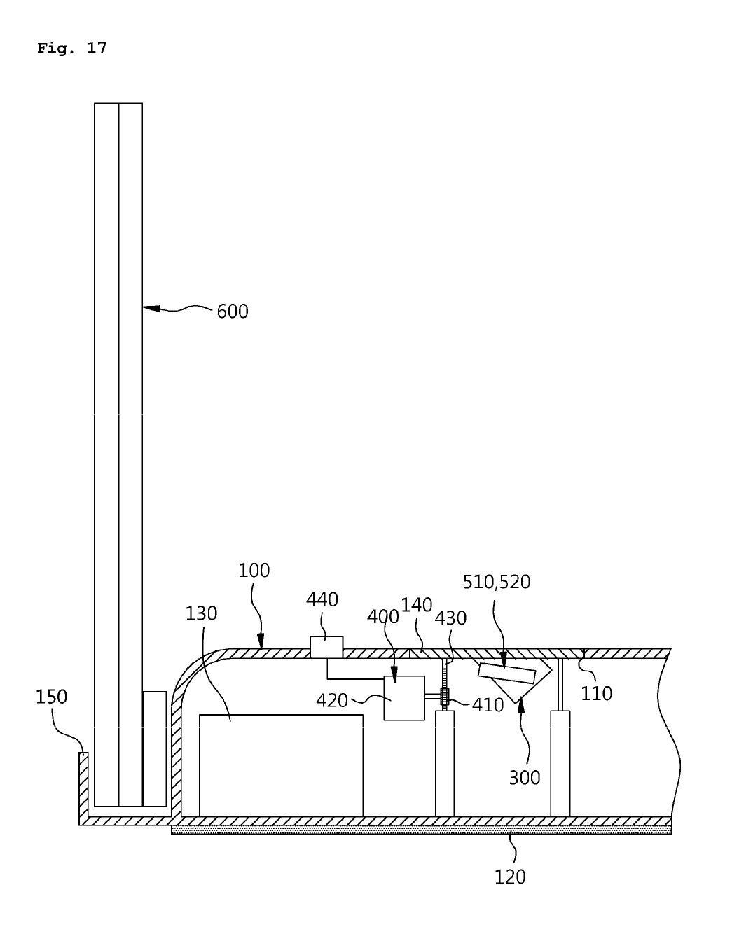

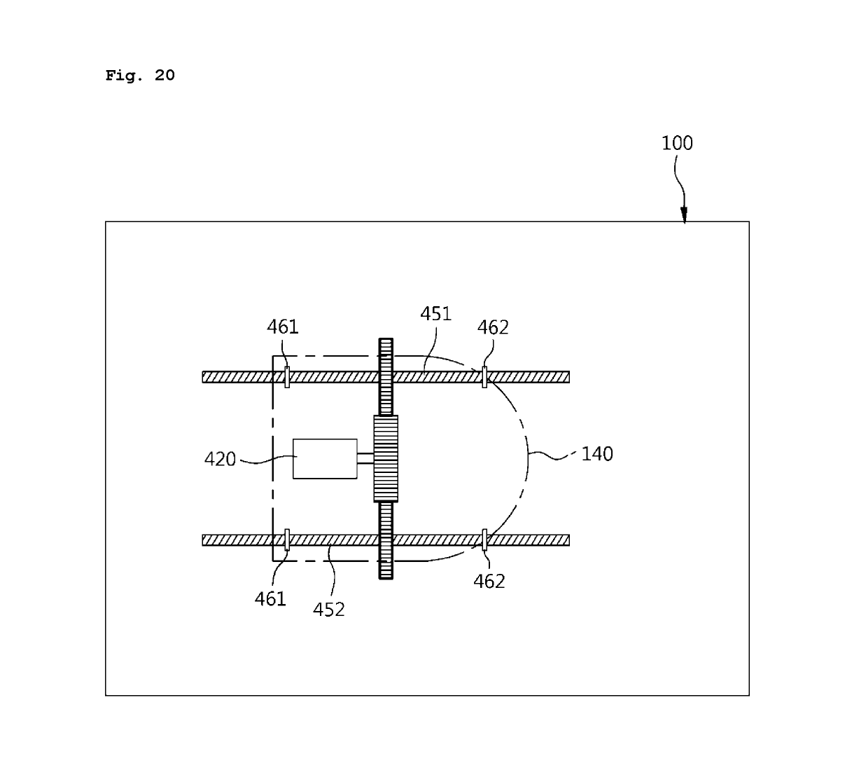

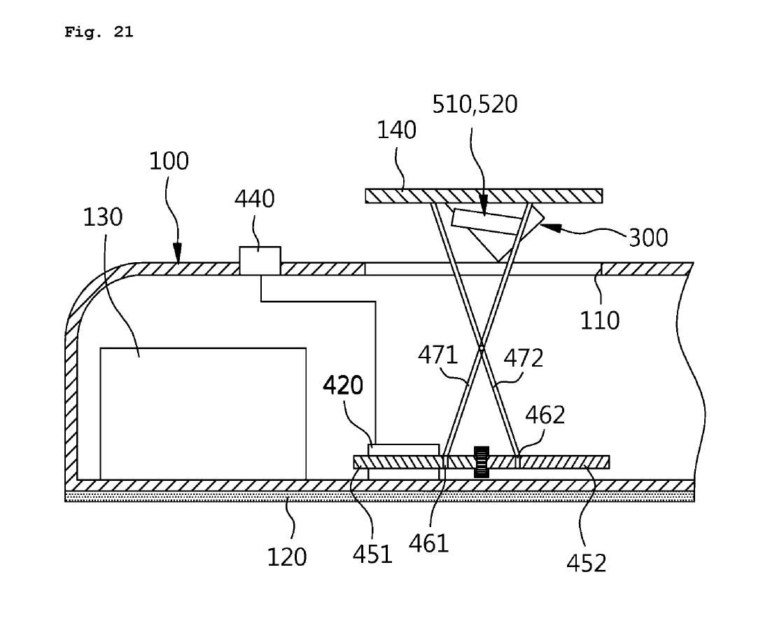

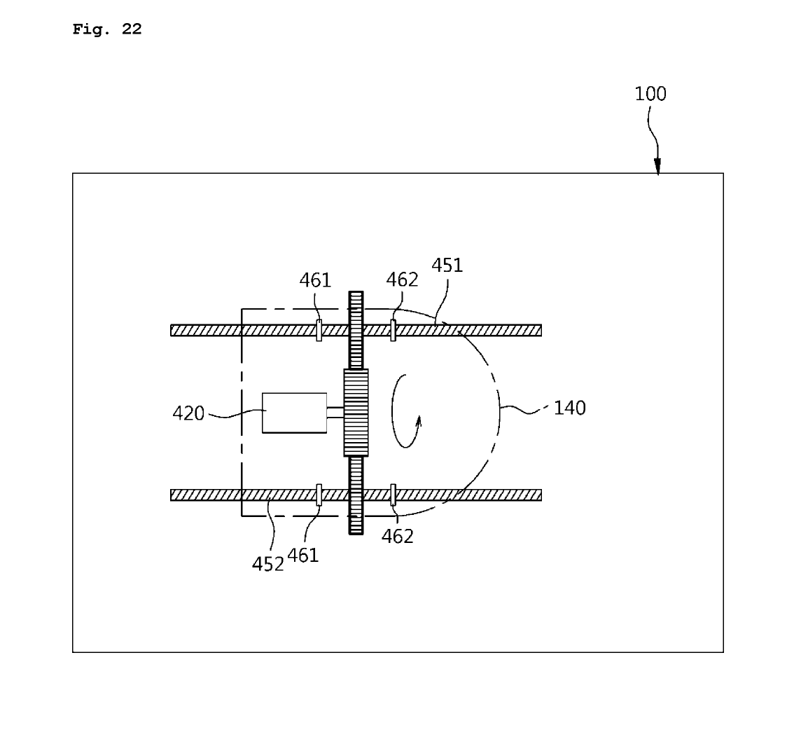

Portable emergency sign devices for a vehicle according to preferred embodiments of the present invention will be described with reference to FIGS. 1 to 22 below.

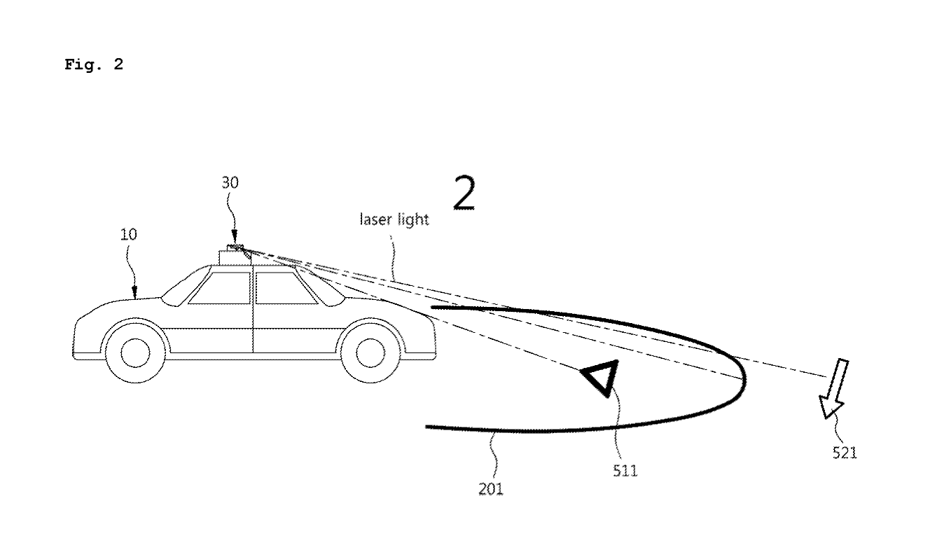

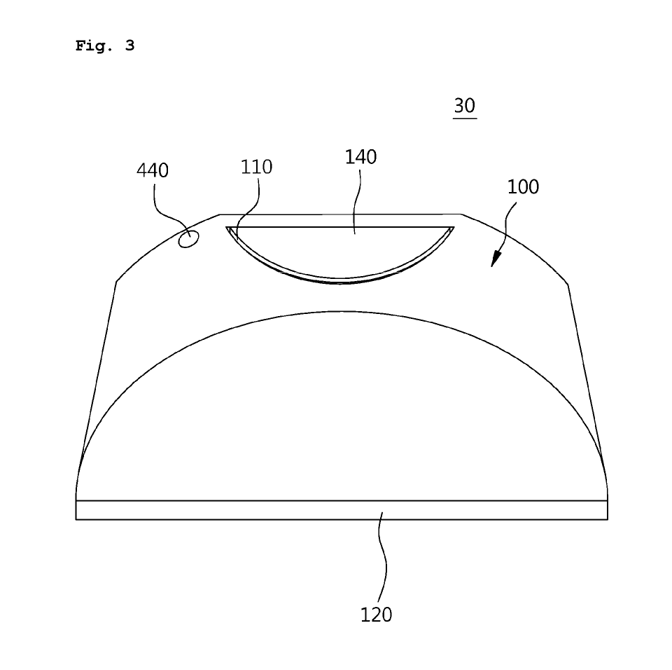

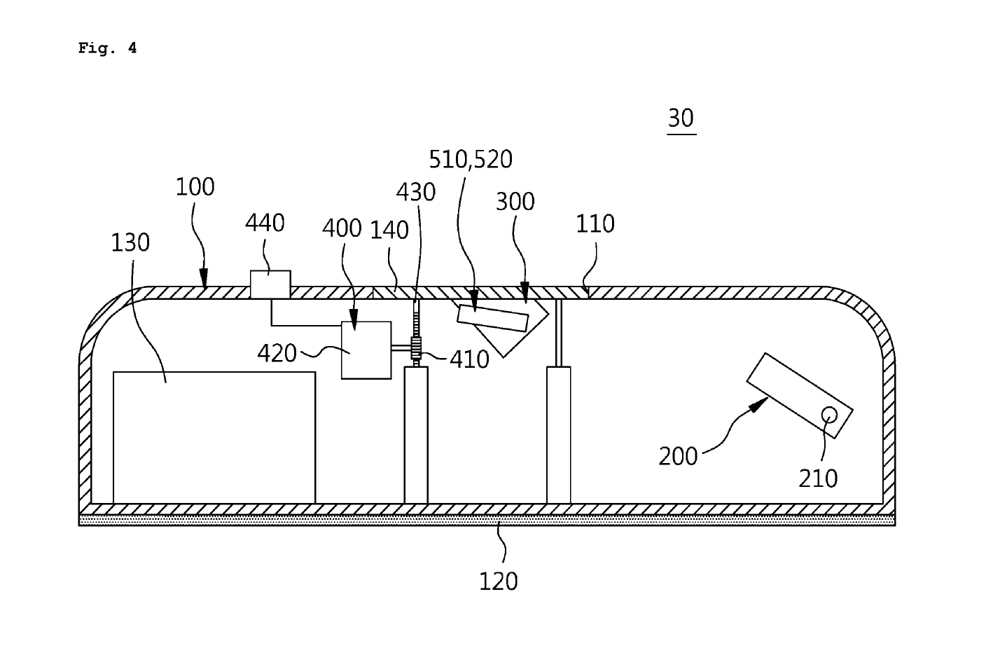

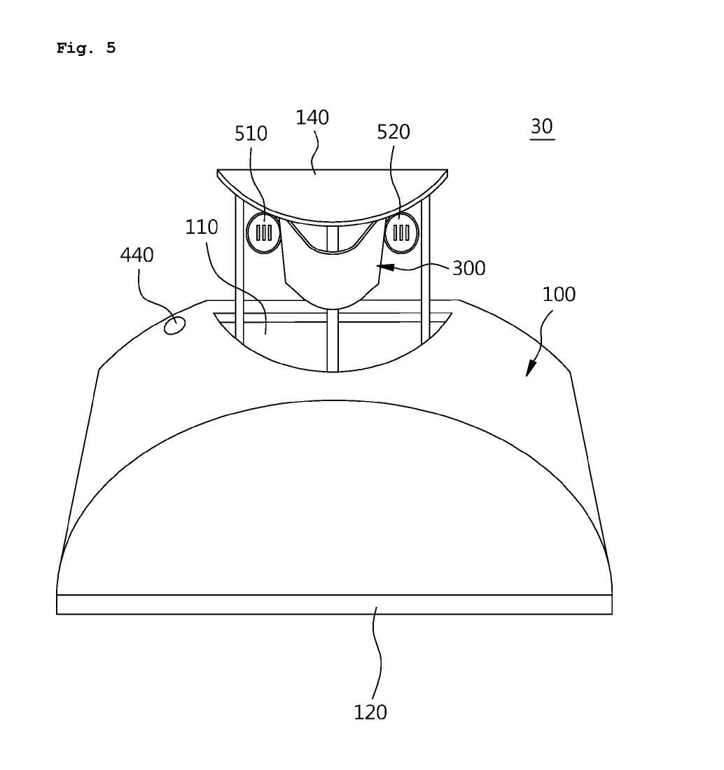

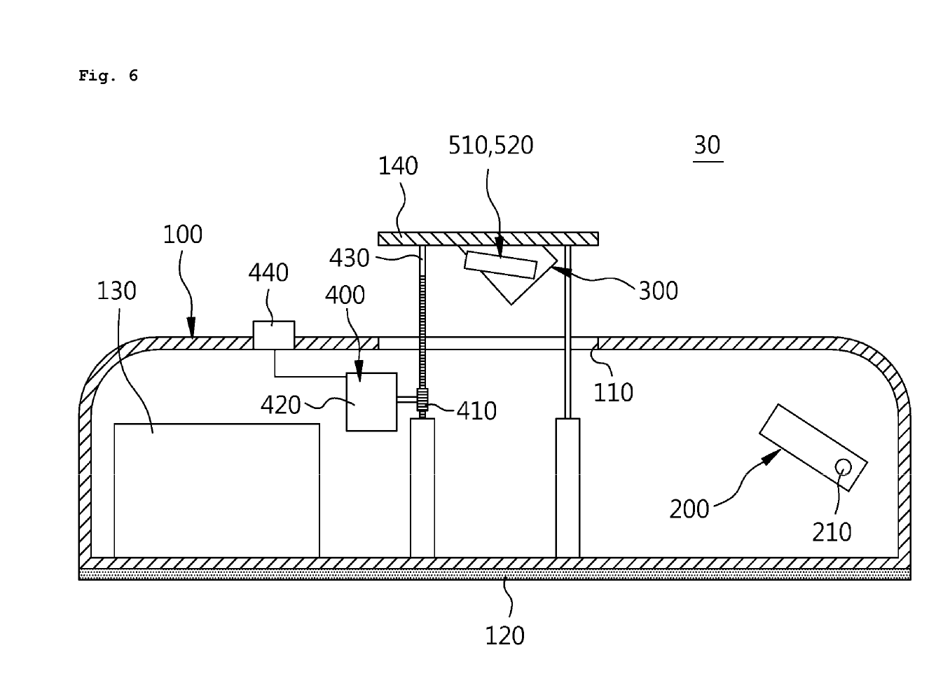

FIG. 1 is a plan view illustrating the state in which a portable emergency sign device for a vehicle according to an embodiment of the present invention is installed; FIG. 2 is a front view illustrating the state in which the portable emergency sign device for a vehicle according to the embodiment of the present invention is installed; FIG. 3 is a perspective view illustrating the state in which the portable emergency sign device for a vehicle according to the embodiment of the present invention is not in use, when viewed from the front; FIG. 4 is a view illustrating the internal state in which the portable emergency sign device for a vehicle according to the embodiment of the present invention is not in use; FIG. 5 is a perspective view illustrating the state in which the portable emergency sign device for a vehicle according to the embodiment of the present invention is in use, when viewed from the front; and FIG. 6 is a view illustrating the internal state in which the portable emergency sign device for a vehicle according to the embodiment of the present invention is in use.

As shown in these drawings, a portable emergency sign device for a vehicle (hereinafter referred to as an “emergency sign device”) 30 according to an embodiment of the present invention is configured to include a case body□100, a region display laser oscillator 200 and a reflector 300, and enables the location region of a vehicle to be displayed using laser light.

The emergency sign device is described in greater detail below based on the components of the emergency sign device.

First, the case body□100 is a component that forms the appearance of the emergency sign device 30 according to the present invention.

The case body□100 is formed in a box shape that provides an installation space, and is provided in a portable form so that it can be moved and installed. Although not shown in the drawings, it may be more preferred that any one wall surface of the case body 100 is configured to be selectively closed and opened and thus it may be possible to replace and repair various types of components installed within the installation space of the case body 100.

The appearance of the case body 100 may be famed in a cylindrical shape, may be formed in a polygonal box shape, may be formed in a cone, triangular pyramid or another polypyramid shape, or may be formed in a dome or tunnel structure.

Furthermore, a through hole 110 is formed through the top surface of the case body 100. The through hole 110 is a hole through which a reflector 300 (which will be described later) is exposed to the outside, and is famed to have a size in connection with the diameter of the reflector 300.

Furthermore, a seat pad 120 made of rubber is provided on the bottom surface of the case body 100. The seat pad 120 functions to prevent the emergency sign device 30 from slipping when the case body 100 is placed on the roof of a vehicle 10 or on a dashboard within the vehicle 10.

Meanwhile, although not shown in the drawings, all the bottom surface of the case body 100 may be made of magnetic material, or at least part of the bottom surface of the case body 100 may be made of magnetic material. That is, the corresponding case body 100 is attached and fastened onto the roof of the vehicle 10 by the magnetic material.

Next, the main laser oscillator 200 is a device that radiates laser light adapted to display the location region of the vehicle 10.

The main laser oscillator 200 is installed within the case body 100, and is configured to receive power from the battery 130 and radiate linear laser light in parallel with a ground surface.

It is preferred that the main laser oscillator 200 is installed within the case body 100 so that the angle thereof can be adjusted, thereby adjusting the location at which the laser light is displayed.

It will be apparent that the main laser oscillator 200 may be configured such that the rotation axis 210 thereof is operated in conjunction with a lifting and lowering unit 400 (which will be described later). That is, it is preferred that, as the lifting and lowering unit 400 is lifted or lowered, the inclination angle of the main laser oscillator 200 is changed and always directed toward the reflector 300. In this case, the rotation axis 210 of the region display laser oscillator 200 may be operated in conjunction with the lifting and lowering unit 400 using, for example, a conjunction gear (not shown).

Next, the reflector 300 is a mirror that reflects the laser light radiated by the main laser oscillator 200 so that the laser light can be radiated onto a road surface.

The reflector 300 is installed such that it can be selectively projected out of and accommodated within the case body 100 by the lifting and lowering unit 400. That is, the reflector 300 is projected out of the case body 100 when the emergency sign device 30 is in use, and is accommodated within the case body 100 and prevented from being damaged when the emergency sign device 30 is not in use.

In this case, the lifting and lowering unit 400 is a unit that is configured to selectively lift and lower the reflector 300. For example, the lifting and lowering unit 400 includes a drive motor 420 configured to have a pinion 410, and a rack 430 configured such that it is engaged with the pinion 410 and selectively lifted and lowered along the pinion 410 and such that the reflector 300 is installed thereon. The reflector 300 is fixedly installed on the rack 430. An operation switch 440 configured to control the operation of the drive motor 420 is provided on the outer surface of the case body 100.

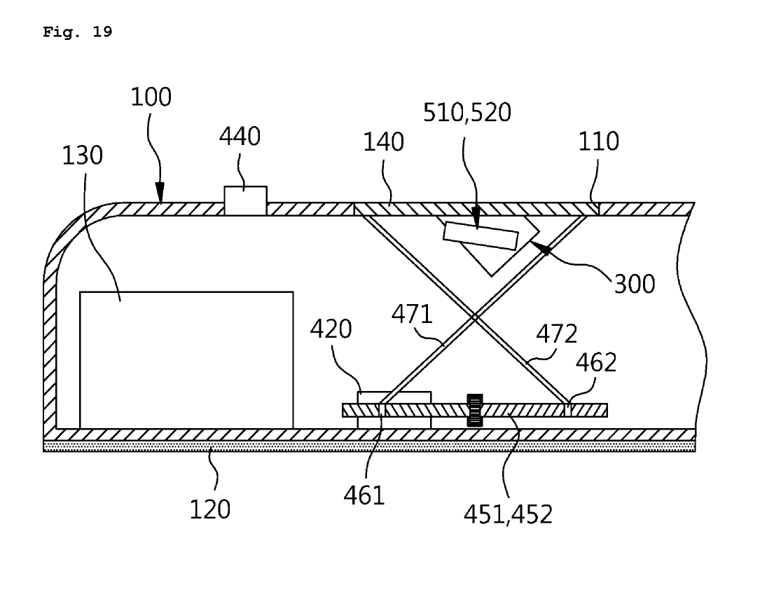

It will be apparent that the lifting and lowering unit 400 may be configured in a lift structure. That is, as shown in FIGS. 19 to 22, the lifting and lowering unit 400 includes two rotation axes 451 and 452 configured to be rotated in opposite directions by the driving of the drive motor 420, movable members 461 and 462 coupled to both ends of the two rotation axes 451 and 452 in a screw manner and configured to be laterally moved as the rotation axes 451 and 452 are rotated, and a plurality of links 471 an 472 configured to connect the movable members 461 and 462 to the reflector 300 (or a portion where the reflector 300 is installed). In this case, the links 471 and 472 may be configured to cross each other, and, thus, may lift or lower the reflector 300 (or the portion where the reflector 300 is installed) while being collapsed or erected as the movable members 461 and 462 move laterally.

Additionally, an opening and closing cover 140 configured to selectively open and close the through hole 110 of the case body 100 while being lifted or lowered along with the reflector 300 is provided in the top of the reflector 300. That is, the opening and closing cover 140 closes the through hole 110 and prevents impurities from entering into the case body 100 when the emergency sign device 30 is not in use, and prevents rain or snow from being attached onto the reflector 200 when the emergency sign device 30 is in use, thereby enabling a sign 201 to be clearly displayed regardless of weather.

In particular, for example, the reflector 300 may be formed such that it is gradually forwardly projected along a direction toward the center thereof and is thus rounded. The reason for this is to reflect the laser light radiated by the main laser oscillator 200 so that the sign (hereinafter referred to as the “region display sign”), i.e., a red line 201, displayed by the laser light is displayed in a parabolic (elliptical) form that partially surrounds a region behind the corresponding vehicle 10. That is, the elliptical region display sign 201 adapted to partially surround the vehicle 10 in trouble is provided, and thus the following vehicle can more accurately become aware of a traffic lane 20 on which the vehicle 10 in trouble is located, thereby enabling the rapid avoidance of the vehicle 10 in trouble.

Furthermore, the reflector 300 is installed to be inclined in connection with the angle at which the main laser oscillator 200 is installed. That is, the reflector 300 is installed to be inclined in a vertical direction, and thus the region display sign 201 is enabled to be displayed at a designated location (for example, on a ground surface backwardly 50 M spaced from a vehicle in trouble).

Meanwhile, according to an embodiment of the present invention, the emergency sign device 30 further includes one or more auxiliary laser oscillators 510 and 520.

That is, the following vehicle is enabled to more clearly become aware of a vehicle in trouble by additionally providing the auxiliary laser oscillators 510 and 520 that perform functions different from that of the above-described main laser oscillator 200.

These auxiliary laser oscillators 510 and 520 include one or more of an access blocking sign laser oscillator 510 and a traffic lane change guidance laser oscillator 520.

In this case, the access blocking sign laser oscillator 510 is a laser oscillator that radiates laser light onto a ground surface in order to display a sign 511 adapted to block the approach of the following vehicle (hereinafter referred to as the “access blocking sign”), such as a warning triangle. The access blocking sign 511 is displayed by the access blocking sign laser oscillator 510 in addition to the region display sign 201 indicating the location region of the vehicle 10 that is displayed by the region display laser oscillator 200, and thus the driver of the following vehicle can more accurately become aware of the presence of the vehicle 10 in trouble.

Furthermore, the traffic lane change guidance laser oscillator 520 is a laser oscillator that radiates laser light onto a ground surface in order to display a sign 521 adapted to guide the following vehicle through the avoidance of a traffic lane where the vehicle 10 in trouble is located (hereinafter referred to as the “traffic lane change guidance sign”). In this case, for example, the traffic lane change guidance sign 521 may be an arrow, as shown in the drawings.

The above-described auxiliary laser oscillators 510 and 520 are configured such that each of the auxiliary laser oscillators 510 and 520 is located on one or all of both sides of the reflector 300, and thus the auxiliary laser oscillators 510 and 520 are exposed out of the case body 100 and display respective signs.

Furthermore, it is preferred that the operations of the respective auxiliary laser oscillators 510 and 520 are performed in accordance with the intention of a user. It will be apparent that programming may be made such that each of the auxiliary laser oscillators 510 and 520 is operated in conjunction with the region display laser oscillator 200 when the emergency sign device 30 is operated.

Meanwhile, although not shown, any one of the auxiliary laser oscillators 510 and 520 is implemented as a trouble type display laser oscillator or a flare signal-type laser oscillator.

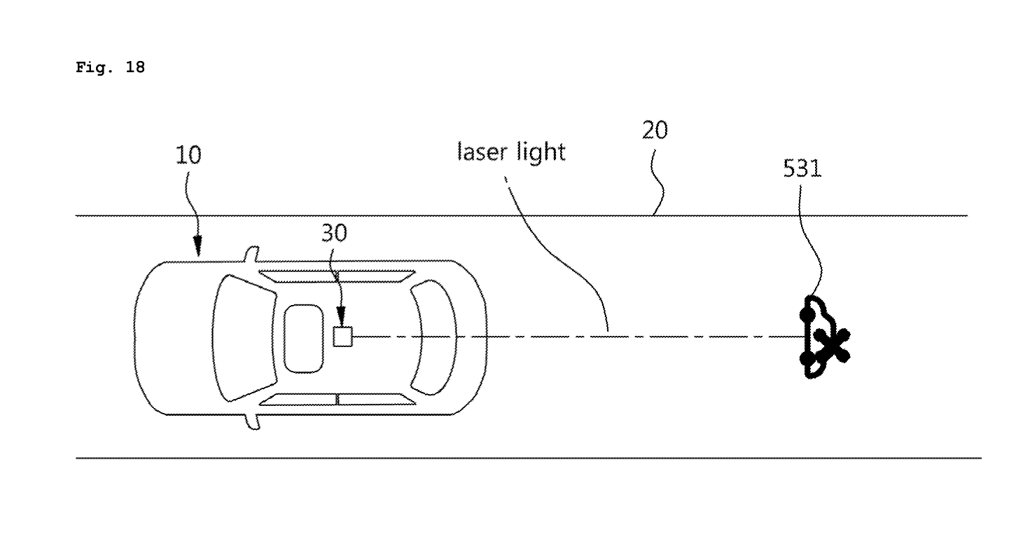

In this case, the trouble type display laser oscillator (not shown) is a laser oscillator that radiates laser light onto a ground surface in order to display a sign 531 indicating the type of trouble of the vehicle 10 (hereinafter referred to as the “trouble type display sign”) (see FIG. 18). In this case, the trouble type display sign 531 may be a diagram indicating that the vehicle is in the process of repairing, as shown in the drawing. Alternatively, a diagram indicating lack of fuel, a diagram indicating a flat tire, or the like may be used as the trouble type sign. That is, the trouble type display sign 531 is additionally displayed, and thus the driver of the following vehicle can more accurately become aware of the type of trouble of the vehicle 10 in trouble and can provide help or take other measures.

The trouble type display sign 531 may be provided through previous programming, and may be selectively output by a user via the corresponding trouble type display laser oscillator. Alternatively, a filter (not shown) through which the corresponding sign 531 is formed may be located in front of the trouble type display laser oscillator, and thus may be selectively output.

Furthermore, the flare signal-type laser oscillator is a laser oscillator that radiates flickering laser light rearward, and radiates laser light rearward, other than onto a ground surface, in a flickering manner so that the following vehicle can more accurately become aware of the vehicle 10 in trouble.

In the following, the above-described emergency sign device 30 according to the embodiment of the present invention is described in detail.

First, in a general traveling situation, the emergency sign device 30 is accommodated within the vehicle 10. For example, the emergency sign device 30 may be used for the purpose of decoration in the state of being placed on a dashboard.

In this case, since the seat pad 120 is provided on the bottom surface of the case body 100 constituting part of the emergency sign device 30, the emergency sign device 30 may be maintained in the state of being stably seated on the dashboard within the vehicle 10.

If an unintentional accident is encountered or a breakdown of the vehicle 10 occurs during traveling, the emergency sign device 30 is installed on the roof of the corresponding vehicle 10 in the state in which the vehicle 10 is stopped.

That is, since the driver installs the emergency sign device 30 without alighting from the vehicle 10, a safety accident attributable to the alighting of the driver can be prevented.

In this case, since the seat pad 120 is provided on the bottom surface of the case body 100 constituting part of the emergency sign device 30, the emergency sign device 30 can be stably maintained in the state of being stably seated on the roof of the vehicle 10.

Furthermore, the emergency sign device 30 is enabled to display the elliptical region display sign 201 on a ground surface behind the corresponding vehicle 10 in trouble by exposing the reflector 300 out of the case body 100 through the manipulation of the operation switch 440 provided on the case body 100 and also operating the main laser oscillator 200.

That is, since the laser light is radiated in a lateral linear form but the reflector 300 that reflects the laser light onto a ground surface is gradually forwardly projected along a direction toward the center thereof and is thus rounded, the region display sign 201 generated by the laser light is represented in a parabolic (or elliptical) form that partially surrounds a region behind the corresponding vehicle 10.

Accordingly, the following vehicle that is approaching from the rear can become aware of the elliptical region display sign 201 generated by the laser light, thereby accurately becoming aware of the location of the vehicle 10 in trouble.

Furthermore, during the above-described use, a user may additionally operate the auxiliary laser oscillators 510 and 520 as desired.

That is, additional measures may be taken via the auxiliary laser oscillators 510 and 520. In greater detail, the following vehicle may be guided through the avoidance of a vehicle in trouble in order to avoid a traffic lane where the vehicle in trouble is located via the traffic lane change guidance sign 521 generated by the traffic lane change guidance laser oscillator 520, or the following vehicle is made to more accurately become aware of the presence of the vehicle 10 in trouble and is additionally made to become aware of the approximate location of the corresponding vehicle 10 in trouble via the access blocking sign 511 generated by the access blocking sign laser oscillator 510.

As a result, since the above-described emergency sign device 30 according to the present invention is provided in a portable form, a drive can place the emergency sign device 30 on the roof of a corresponding vehicle 10 in the state of sitting on the driver's seat without alighting from the vehicle 10 when a trouble of the vehicle 10 occurs during night driving, thereby enabling a warning to be displayed to the following vehicle.

In particular, since the emergency sign device 30 according to the present invention provides the elliptical region display sign 201 that partially surrounds a region where a corresponding vehicle in trouble is located, the following vehicle can accurately become aware of and rapidly avoid the traffic lane 20 where the vehicle 10 in trouble is located.

Furthermore, in accordance with the emergency sign device 30 according to the present invention, the presence of the vehicle 10 in trouble can be more accurately identified through the additional provision of the auxiliary laser oscillators 510 and 520, and the following vehicle can provide help through the recognition of the type of trouble.

Meanwhile, the emergency sign device 30 according to the present invention is not limited to the structures of the above-described embodiments.

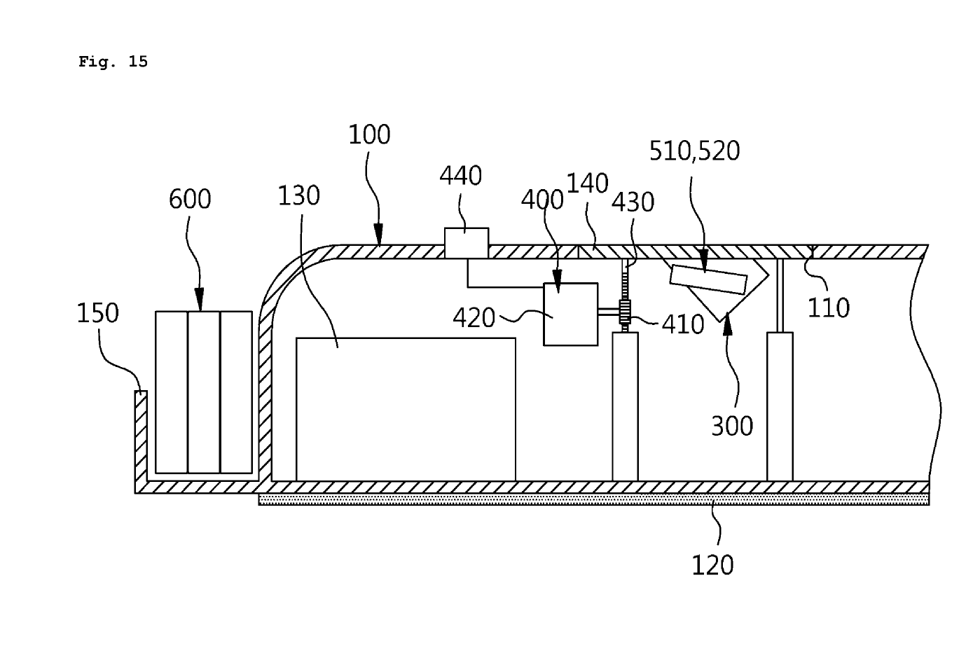

That is, as shown in FIGS. 15 to 17, a warning triangle 600 may be additionally installed behind the case body 100 of the emergency sign device 30 according to the present invention so that the warning triangle 600 can be selectively folded and extended.

In this case, the warning triangle 600 substitutes for a common warning triangle when a trouble occurs in the vehicle 10 during daytime, and the case body 100 of the emergency sign device 30 according to the present invention functions as a support that supports the warning triangle 600.

For this purpose, a triangle holder 150 configured to accommodate and place the warning triangle 600 is further formed behind the case body 100, thereby enabling the warning triangle 600 to be more stably accommodated and installed. It will be apparent that the warning triangle 600 is configured to be always accommodated inside the triangle holder 150 behind the case body 100 in the state of being folded.

As described above, the portable emergency sign device for a vehicle according to the present invention may be subjected to various modifications and variations.

As described above, the portable emergency sign device for a vehicle according to the present invention provides an advantage in that the emergency sign device is provided in a portable form, and thus a driver can place the emergency sign device on the roof of a vehicle in the state of sitting on the driver's seat without alighting from the vehicle when a trouble of the vehicle occurs during night driving, thereby enabling a warning to be displayed to the following vehicle.

In particular, the portable emergency sign device for a vehicle according to the present invention provides an advantage in that the emergency sign device is configured to provide the elliptical region display sign that partially surrounds a region where a corresponding vehicle in trouble is located, and thus the following vehicle can more accurately become aware of a traffic lane where the vehicle in trouble is located, thereby enabling rapid avoidance.

Furthermore, the portable emergency sign device for a vehicle according to the present invention provides an advantage in that the presence of a vehicle in trouble can be more accurately identified through the additional provision of the auxiliary laser oscillators and the following vehicle can provide help through the recognition of the type of trouble.

Although the specific embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. A portable emergency sign device for a vehicle, comprising:
a box-shaped case body configured to provide an installation space therein;
a main laser oscillator installed within the case body, and configured to radiate laser light adapted to display a location region of a vehicle in trouble; and
a reflector installed to be selectively projected out of and accommodated within the case body, and configured to reflect the laser light, radiated by the main laser oscillator, onto a road surface.

2. The portable emergency sign device of claim 1, wherein:
a through hole is formed through a top surface of the case body; and
the reflector is installed to be exposed out of the case body through the through hole by a lifting and lowering unit.

3. The portable emergency sign device of claim 2, wherein the lifting and lowering unit includes a drive motor configured to have a pinion, and a rack configured such that the rack is engaged with the pinion and selectively lifted and lowered along with the pinion and such that the reflector is installed on the rack.

4. The portable emergency sign device of claim 2, wherein an operation switch configured to control operation of the drive motor is provided on an outer surface of the case body.

5. The portable emergency sign device of claim 2, wherein an opening and closing cover configured to selectively open and close the through hole of the case body while being selectively lifted and lowered along with the reflector is provided above the reflector.

6. The portable emergency sign device of claim 1, wherein the reflector is gradually forwardly projected along a direction toward a center thereof and is thus rounded, and enables the laser light, radiated by the main laser oscillator, to display a sign adapted to partially surround a region behind the vehicle in trouble.

7. The portable emergency sign device of claim 1, further comprising an access blocking sign laser oscillator configured to radiate laser light onto a ground surface so that a sign adapted to block approach of a vehicle is displayed.

8. The portable emergency sign device of claim 7, wherein the access blocking sign laser oscillator is located on at least any one of both sides of the reflector.

9. The portable emergency sign device of claim 1, further comprising a traffic lane change guidance laser oscillator configured to radiate laser light onto a ground surface so that a sign adapted to guide a following vehicle through avoidance of a traffic lane where the vehicle in trouble is located is displayed.

10. The portable emergency sign device of claim 9, wherein the traffic lane change guidance laser oscillator is located on at least any one of both sides of the reflector.

11. The portable emergency sign device of claim 1, further comprising a trouble type display laser oscillator configured to radiate laser light onto a ground surface so that a sign adapted to indicate a type of trouble of the vehicle in trouble is displayed.

12. The portable emergency sign device of claim 11, wherein the trouble type display laser oscillator is located on at least any one of both sides of the reflector.

13. The portable emergency sign device of claim 11, wherein the sign adapted to indicate a type of trouble of the vehicle in trouble is at least any one of a diagram indicating that a vehicle is in a process of repairing and a diagram indicating lack of fuel or a flat tire.

14. The portable emergency sign device of claim 1, further comprising a warning triangle installed behind the case body to be selectively folded and extended and configured to perform display so that whether a vehicle is in trouble is recognized during daytime.

15. The portable emergency sign device of claim 14, wherein a triangle holder configured to accommodate and install the warning triangle is formed to be bent behind the case body.

16. The portable emergency sign device of claim 1, further comprising a seat pad made of rubber and provided on a bottom surface of the case body.
